(19) United States
(12) Patent Application Publication
(10) Pub. No.: US 2026/0300319 A1
(43) Pub. Date: Oct. 1, 2026

(54) EVENT-AUGMENTED GENERATION

(71) Applicant: Microsoft Technology Licensing, LLC, Redmond, WA (US)

(72) Inventors: Anders Tungeland GJERDRUM, Troms (NO); Age Andre KVALNES, Akershus (NO); Jan-Ove Almli KARLBERG, Troms (NO)

(21) Appl. No.: 19/093,908

(22) Filed: Mar. 28, 2025

(51) Int. Cl. G06F 16/28; G06F 18/245

(52) U.S. Cl. CPC G06F 16/282; G06F 18/245

(57) ABSTRACT

In various examples, an event-augmented generation tool determines whether to notify a client that an ingress event modifies data associated with a query. For example, a query footprint represents data stored in a data storage system that satisfies a query. In such examples, the event-augmented generation tool generates a predicate set that represents at least a portion of the query footprint. In an embodiment, the predicate set includes a mask representing a set of values and a Bloom filter. In one example, ingress events are evaluated based on the predicate set to determine whether data corresponding to the ingress event satisfies the query.

### BACKGROUND

Typically productivity and/or collaboration workflows often revolve around various objects such as chat threads, emails, documents, task, and other data. These objects exhibit relational structures that describe interdependencies between people and objects, often represented using relational models or graph representations. These graphs describe workflow-oriented connections between enterprise users and workflow objects, answering questions about document modifications, shared documents, and more. Furthermore, this data is often stored in federated and/or distributed storage systems that are designed to manage and integrate data across multiple, often disparate, storage systems and databases. These systems provide a unified interface for accessing and managing data, regardless of where it is physically stored. This approach is particularly useful in cloud computing environments, where data may be distributed across various locations and platforms. In this manner, users can search and/or query multiple disparate data sources from a single system and/or service. However, frequent interrogation of these data sources and dense relational connections for relevant data can be computationally expensive. Traditional caching approaches, while useful, have limitations. These limitations necessitate a more efficient mechanism for maintaining up-to-date responses to queries, especially in the context of modern-day enterprise-level productivity and/or collaboration workflows.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments described herein are directed to event-augmented generation for machine learning models based on monitoring changes to data objects stored in a federated and/or distributed storage system. For example, a Bloom filter and/or other mechanism is used to monitor ingestion events to enable reactive event-based updates to client-side cached content such as content generated by a machine learning model. In various embodiments, a subscription mechanism and/or push-based retrieval is used to inspect ingress data and conditionally notify clients of changes. For example, a client submits a standing query on documents a particular user has modified in the last two days. Continuing this example, when an ingress operation is obtained by a server computer system, the server computer system uses a Bloom filter or otherwise inspects the ingress operation to determine if the query is satisfied and notifies the client associated with the standing query.

In various embodiments, a machine learning model such as a large language model (LLM) and/or artificial intelligence (AI) assistant provides various capabilities such as semantically searching, collating, and refining knowledge into responses tailored and grounded in personalized content. Furthermore, in various embodiments, event-augmented generation is integrated with the subscription mechanism and/or push-based retrieval and the federated and/or distributed storage system capable of querying data used by the machine learning model. For example, the machine learning model generates meeting insights and/or context information based on emails and documents associated with a calendar event. Continuing this example, new emails and/or changes to the documents cause the meeting insight to become stale and/or inaccurate. Therefore, in various embodiments, changes to the underlying data are detected based on a query footprint, which is defined by a Bloom filter, which stores an indexed representation of the query footprint. For example, as a result of an ingress operation modifying an element within the query footprint, a client (for instance, the machine learning model) associated with the query footprint is notified. Furthermore, in an embodiment, the query footprint represents complex queries that include ranges, dates, equivalence, pattern matching, Boolean logic, set membership, existence, negation, and/or other predicates that can be represented in a query.

In various embodiments, the Bloom filters store indexed representations of query footprints including representations of predicate sets such as range predicates, inclusion, temporal predicates, and equivalence predicates. In one example, the predicate sets are represented using a mask and the Bloom filter. In various embodiments, a bitmask is used to model the predicate sets. Furthermore, in some embodiments, hierarchical predicate sets are used to model complex queries and optimize performance. For example, a decision tree is used to determine whether a query footprint changed based on an ingress operation.

### BRIEF DESCRIPTION OF THE DRAWINGS

The present disclosure is described in detail below with reference to the attached drawing figures, wherein:

FIG. 1 depicts an environment in which one or more embodiments of the present disclosure can be practiced.

FIG. 2 depicts an environment in which an event-augmented generation tool determines whether to notify a client, in accordance with at least one embodiment.

FIG. 3 depicts an environment in which a plurality of predicate sets are organized into a hierarchical structure, in accordance with at least one embodiment.

FIG. 4 depicts an example process flow for generating predicate sets and Bloom filters used to evaluate ingress events to determine whether to notify a client associated with a query, in accordance with at least one embodiment.

FIG. 5 depicts an example process flow for determining to notify a client based on an ingress event and a query footprint, in accordance with at least one embodiment.

FIG. 6 depicts an example process flow for determining data included in an ingress event that modifies a query footprint, in accordance with at least one embodiment.

FIG. 7 is a block diagram of a Large Language Model that uses particular inputs to make particular predictions, according to some embodiments.

FIG. 8 is a block diagram of an exemplary computing environment suitable for use in implementations of the present disclosure.

FIG. 9 is a block diagram of an example computing environment in which embodiments described herein may be employed.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, such as to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-useable instructions stored on computer storage media. The methods may be provided by a stand-alone application, a service or hosted service (stand-alone or in combination with another hosted service), or a plug-in to another product, to name a few.

Aspects of the present disclosure relate to technology for improving electronic communication technology and enhanced computing services for a user, based on an event-augmented generation system that is capable of monitoring ingress operations and notifying clients (for instance the user and/or an application such as an AI assistant executed by the user). Traditional distributed data storage systems often struggle with queries that consume computing resources and execute frequently. These traditional distributed data storage systems implement some optimization techniques such as caching, index discovery, and eager predicate evaluation to reduce the cost of query execution; however, the queries are still frequently executed and the problem persists. For example, service providers, including federated and/or distributed storage systems, include tenants that span millions of users connected in a single coherent graph structure. Furthermore, in such examples, the relationships in these graph structures describe workflow-oriented connections between users and workflow objects (for instance emails, documents, calendar invites, access rights, etc.).

Furthermore, these traditional systems are sometimes combined with clients that include machine learning models that process and evaluate data associated with these queries. However, current models are limited by persistent memory tied to a training corpus and are also limited by the recency of training. Therefore, these models are often coupled with long-term memory for context persistence such as RAG (Retrieval-Augmented Generation) for extended up-to-date knowledge. In these traditional systems, queries are used to answer questions such as which documents where modified around an immediate organization or what documents are shared in a group. However, in such examples, the size and complexity of the tenants often increase the amount of computing resources needed to execute such queries. As a result, the combination of current models with traditional systems increases consumption of computing resources without addressing the limitations of the underlying systems, such as the caching systems.

For example, global caching policies of these traditional systems often fail to meet user expectations on data freshness, are complex policies increasing the difficulty in implementing the global caching policies, and are suboptimal for many use cases. In addition, traditional systems often needlessly re-execute queries even when no change in the underlying data has occurred as a result of the caching policy being decoupled from the ingress operation describing change events (for instance, modifications to documents). Traditional caching systems also incur significant memory overhead from storing multiple permutations of similar data. In one example, for data that is subject to discretionary access control, clients cannot share cache between different users, reducing the benefits of traditional caching altogether.

In various embodiments, the event-augmented generation system provides a reactive event-based mechanism, which inspects ingress data to conditionally notify a client of a change in the underlying dataset. In one example, a subscription mechanism for graph structures is used to enable reactive event-based updates to client-side cached content. In various embodiments, ingress data is inspected using a Bloom filter and, as a result of the ingress data satisfying the condition represented in the Bloom filter, clients are notified of changes, thereby improving fetch precision and reducing unnecessary query executions. In an embodiment, a distributed storage service capable of querying relational databases using a domain-specific language evaluates queries and provides data. Furthermore, in various embodiments, an event-augmented generation tool, and/or components thereof, detects changes to a data subject to a query based on a query footprint. In one example, an ingress operation modifies an element within the query footprint, the query owner is notified.

In various embodiments, the Bloom filter stores an indexed representation of the query footprint that is used to inspect an ingress operation to determine whether the operation mutates the query and/or modifies data subject to the query associated with the Bloom filter. For example, the Bloom filter includes a number of bits and hash functions used to deduce membership of an ingress operation to the query footprint, allowing for an optimal tradeoff between storage and accuracy. The Bloom filter data structure, in various embodiments, does not result in a false negative but, in some situations (for instance, as a result of an insufficient number of bits being allocated), does produce false positives. As a result, in such embodiments, an appropriately sized Bloom filter reliably indicates whether an ingress operation modifies, creates, deletes, or otherwise impacts a particular query footprint associated with the Bloom filter. For example, Bloom filters allow the event-augmented generation tool to store large sets of query footprints with minimal memory usage, providing a quick and efficient means to determine whether an element is part of a query footprint in order to efficiently determine to notify a client needs of a change. Continuing this example, while Bloom filters can produce false positives, false negatives cannot be produced, ensuring that relevant changes are not missed.

Furthermore, in an embodiment, the query footprint is generated based on a submitted query (for instance submitted by a user, client application, and/or AI assistant). In addition, in some embodiments, bitmasking operations are used for efficient utilization of computing resources to represent predicate sets within the query. For example, a particular query can include any number of predicates such as equality, value ranges, set membership, pattern matching, Boolean logic, temporal values, existence, and/or negation. In an embodiment, a bitmask is used to represent a particular predicate. In one example, a particular query includes the predicate a “count greater than five,” with the set of values that satisfy this predicate including six, seven, eight, . . . continuing to infinity. Continuing this example, a bitmasking operation is used to efficiently express and/or model this range of values, where the predicate set is composed of the mask and the Bloom filter. In this particular example, the binary representation of the mask is “11100.” In an embodiment, to compute the inclusion test for a value (for instance, a portion of the data included in the ingress operation) on the predicate “count greater than five,” a bitwise AND operation is performed to combine the bitmask (“11100”) with the value. In this embodiment, the resulting bits are used to query the Bloom filter and determine whether the ingress operation modifies data associated with the query footprint. Returning to the example above, any value above 8 will effectively be masked and mapped to the upper bound of the set enabling expression of infinite values.

In various embodiments, predicate sets (for instance, bitmasks and Bloom filters) are optimized to reduce the amount of computing resources consumed to process the predicate sets. In one example, the predicate sets are organized into a hierarchical structure (for instance, a tree structure) based on cardinality. In an embodiment, a query footprint defined by multiple predicate sets is ordered by the cardinality in ascending order. In this manner, by combining the bitmask and Bloom filter into a hierarchical structure, the event-augmented generation tool determines whether a value falls within the desired range and is present in a dataset represented by the query footprint. Furthermore, the hierarchical structure of predicate sets, in various embodiments, enables the event-augmented generation tool to handle complex queries.

Advantageously, the embodiments described herein improve upon conventional systems by providing improvements over existing solutions by enhancing fetch precision, reducing memory usage, providing proactive updates, and improving scalability. This system ensures that clients receive timely and relevant updates, maintaining data freshness without overwhelming the client with unnecessary notifications. Furthermore, the benefit of this approach over a conventional cache is improved fetch precision. More specifically, the percentage of fetch events is reduced and/or limited to events that alter the cached content. In addition, the embodiments described herein improve upon conventional systems by enabling and/or altering the behavior of certain systems (for instance, generative AI systems such as AI agents) to be proactive and increase the level of autonomy of such systems.

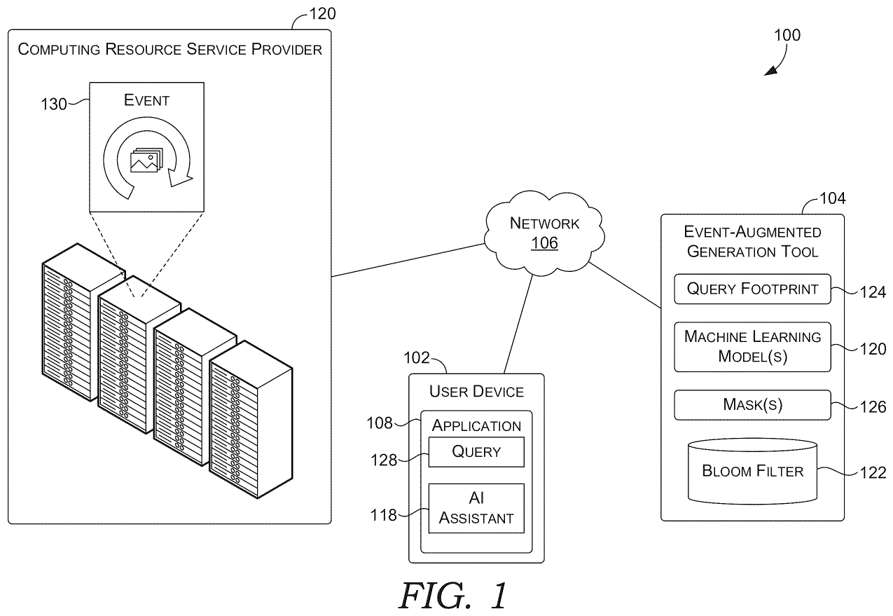

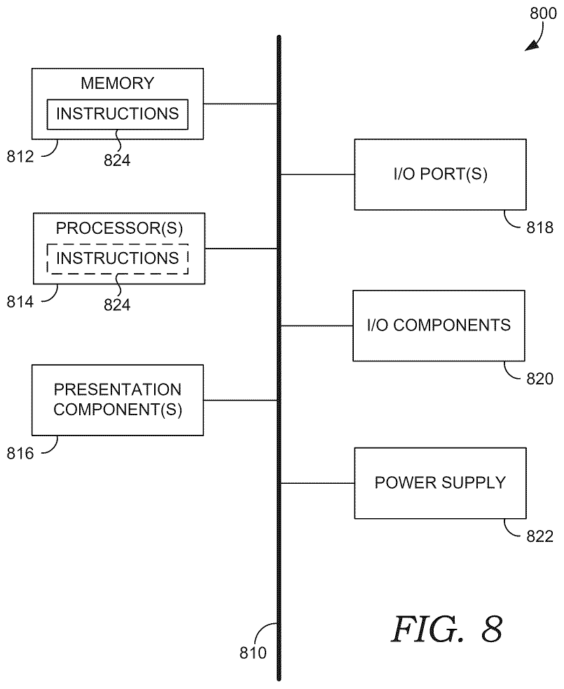

Turning to FIG. 1, FIG. 1 is a diagram of an operating environment 100 in which one or more embodiments of the present disclosure can be practiced. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 8.

It should be understood that operating environment 100 shown in FIG. 1 is an example of one suitable operating environment. Among other components not shown, operating environment 100 includes a user device 102, an event-augmented generation tool 104, computing resource service provider 120, and a network 106. Each of the components shown in FIG. 1 can be implemented via any type of computing device, such as one or more computing devices 800 described in connection with FIG. 8, for example. These components can communicate with each other via network 106, which can be wired, wireless, or both. Network 106 can include multiple networks, or a network of networks, but is shown in simple form so as not to obscure aspects of the present disclosure. By way of example, network 106 can include one or more wide area networks (WANs), one or more local area networks (LANs), one or more public networks such as the Internet, and/or one or more private networks. Where network 106 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 106 is not described in significant detail.

It should be understood that any number of devices, servers, and other components can be employed within operating environment 100 within the scope of the present disclosure. Each can comprise a single device or multiple devices cooperating in a distributed environment. For example, the event-augmented generation tool 104 includes multiple server computer systems cooperating in a distributed environment to perform the operations described in the present disclosure. Similarly, in various embodiments, the computing resource service provider 120 includes multiple server computer systems cooperating in a distributed environment to implement various services that perform operations. For example, the computing resource service provider 120 includes a data storage service that stores data objects including documents, emails, meetings, and other collaborative tasks.

In various embodiments, ingress event(s) 130 involve the intake and processing of data as it enters the computing resource service provider 120 or component thereof, such as the data storage service. For example, in response to a document, email, meeting record, and/or other data object being created or modified, the ingress operation captures this event and updates the data storage service. In various embodiments, the data is indexed and stored in a manner that allows for efficient retrieval and querying. Furthermore, in an embodiment, additional metadata associated with the data object is captured and/or generated. For example, user identification information, date and time, location, modification count, access control information, policy, and/or other information associated with the ingress operation, users, and/or the data object is determined, generated, and/or captured during the ingress operation.

User device 102 can be any type of computing device capable of being operated by an entity (e.g., individual or organization) and obtains data from the event-augmented generation tool 104 and/or a data store, which can be facilitated by the computing resource service provider 120 (e.g., a server operating as a frontend for the data store). The user device 102, in various embodiments, has access to or otherwise maintains an artificial intelligence (AI) assistant 118, which is implemented as a component of an application 108 or as a standalone application. For example, the application 108 includes the AI assistant 118 as a chatbot, virtual assistant, or other component that assists the user of the application 108 to perform various operations.

In various embodiments, the AI assistant 118 includes any number of machine learning models or technologies. In some embodiments, the AI assistant 118 includes, or accesses, a large language model (LLM) that takes, as an input, a prompt, and provides, as output, various insights, answers, responses, and/or other information based on the input. A language model is a statistical and probabilistic tool that determines the probability of a given sequence of words occurring in a sentence (e.g., via Next Sentence Prediction [NSP] or Masked Language Modeling [MLM]). In this way, it is a tool that is trained to predict the next word in a sentence. A language model is called a large language model when it is trained on an enormous amount of data. Some examples of LLMs are Open Pre-trained Transformer (OPT), Fine-tuned Language Net-Text-To-Text Transfer Transformer (FLAN-T5), Bidirectional and Auto-Regressive Transformers (BART), GOOGLE's Bidirectional Encoder Representations from Transformers (BERT), and OpenAI's Generative Pre-trained Transformer (GPT), GPT-3, and GPT-4. For instance, GPT-3 is a large language model with 175 billion parameters trained on 570 gigabytes of text. These models have capabilities ranging from writing a simple essay to generating complex computer codes-all with limited to no supervision. Accordingly, an LLM is a deep neural network that is very large (billions to hundreds of billions of parameters) and understands, processes, and produces human natural language by being trained on massive amounts of text. In embodiments, an LLM generates representations of text, acquires world knowledge, and/or develops generative capabilities. As described, in some embodiments, the AI assistant 118 takes on the form of an LLM, but various other machine learning models can additionally or alternatively be used.

In embodiments, the AI assistant 118 is fine-tuned. Fine-tuning generally refers to the process of retraining a pre-trained model on a new dataset without training from scratch. Fine-tuning typically takes weights of a trained model and uses those weights as the initialization value, which is then adjusted during fine-tuning based on the new dataset. Fine-tuning can be used in cases in which an industry-specific dataset exists that can be used to fine-tune the model. In some implementations, the LLM is fine-tuned on various examples to leverage its text generation ability in association with particular types of data stored by the computing resource service provider 120—for example, generating meeting insights based on emails, meeting transcripts, and/or documents.

The output generated by an LLM may take on any number of forms. As one example, the output may include text that summarizes a document or document assets in a way that resonates with a particular user (for instance, in a manner that highlights or focuses on a feature of interest or other aspect corresponding with a query 128). As another example, the output may include a storyline described in text that corresponds with various data objects (for instance, images or videos) in a particular order. In various embodiments, the AI assistant 118 generates the query 128 for data objects maintained by the computing resource service provider 120 in order to generate the output. Returning to the example above, the AI assistant 118 generates the query 128 for all emails associated with a particular meeting in order to generate meeting insights. In various embodiments, the AI assistant 118 generates the query 128 to obtain data from the computing resource service provider 120 based on a prompt from the user. For example, the user can prompt the AI assistant 118 for content retrieval and/or recommendations for content. In other examples, the user generates the query 128 (for instance, a standing query for all updates by other users to data objects created by the user).

In general, the AI assistant 118, in various embodiments, is integrated into the application 108 and provides productivity and collaboration workflow assistance. In one example, the AI assistant 118 provides document management and collaboration assistance by automating document creation, enabling real-time collaboration, and/or organizing content for easy retrieval. In other examples including email and communication, the AI assistant 118 assists in drafting emails, summarizing long threads, scheduling meetings, and/or providing communication insights to improve team collaboration. In yet other examples, the AI assistant 118 automates repetitive tasks, tracks project progress, and/or optimizes resource allocation. Furthermore, in various embodiments, the AI assistant 118 provides data analysis and reporting, including data insights, automated reporting, and/or predictive analytics. In examples of managing meetings and events, the AI assistant 118 prepares agendas, summarizes discussions, and coordinates events. Furthermore, the AI assistant 118 includes integration with the computing resource service provider 120 to enable knowledge management by creating and maintaining a centralized knowledge base, retrieving relevant content, and/or recommending experts within the organization.

Furthermore, the AI assistant 118, in an embodiment, generates personalized content for a particular user and caches content locally. For example, meeting insights, collaboration suggestions, document creation, and/or other tasks are personalized to the user of the application 108 and stored locally. As described in greater detail below, the data used by the AI assistant 118 to generate such personalized content (and other output data described in the present disclosure) is maintained by the computing resource service provider 120 and may change. For example, the user can collaborate on documents and/or events with other users who can modify and/or change data stored by the computing resource service provider. Continuing this example, such changes can cause the content generated by the AI assistant 118 to become stale and/or out-of-date. As such, in various embodiments, the event-augmented generation tool 104 provides a mechanism to inspect ingress events 130 and determine whether the content generated by the AI assistant 118 needs to be updated.

In some implementations, user device 102 is the type of computing device described in connection with FIG. 8. By way of example and not limitation, the user device 102 can be embodied as a personal computer (PC), a laptop computer, a mobile device, a smartphone, a tablet computer, a smart watch, a wearable computer, a personal digital assistant (PDA), a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors and one or more computer-readable media. The computer-readable media can also include computer-readable instructions executable by the one or more processors. In an embodiment, the instructions are embodied by one or more applications, such as application 108 shown in FIG. 1. Application 108 is referred to as a single application for simplicity, but its functionality can be embodied by one or more applications in practice.

In various embodiments, the application 108 includes any application capable of facilitating the exchange of information between the user device 102, the AI assistant 118, the event-augmented generation tool 104, and/or the computing resource service provider 120. For example, the application 108 includes an operating system that includes the AI assistant 118 to provide enterprise-level productivity and collaboration tools and support. In some implementations, the application 108 comprises a web application, which can run in a web browser, and can be hosted at least partially on the server-side of the operating environment 100. In addition, or instead, the application 108 can comprise a dedicated application, such as an application being supported by the user device 102 and event-augmented generation tool 104. In some cases, the application 108 is integrated into the operating system (e.g., as a service). It is therefore contemplated herein that “application” be interpreted broadly.

For cloud-based implementations, for example, the application 108 is utilized to interface with the functionality implemented by the event-augmented generation tool 104 and/or computing resource service provider 120. In some embodiments, the components, or portions thereof, of the event-augmented generation tool 104 are implemented on the user device 102 or other systems or devices. Thus, it should be appreciated that the components illustrated in FIG. 1, in some embodiments, are provided via multiple devices arranged in a distributed environment that collectively provide the functionality described herein. Additionally, other components not shown can also be included within the distributed environment.

As illustrated in FIG. 1, the event-augmented generation tool 104 includes query footprints 124, machine learning models 120, masks 126, and Bloom filters 122. As described below, the event-augmented generation tool 104 obtains ingress events 130 from the computing resource service provider 120 and determines, based on the query footprints 124, whether to notify one or more clients. In one example, data used to generate a meeting insight by the AI assistant 118 is updated during an ingestion event, the event-augmented generation tool 104 detects the update based on a particular query footprint and notifies the user device 102. In various embodiments, the query footprint(s) 124 define a set of data objects that are relevant to a specific query such as the query 128. In one example, a query footprint indicates data within an enterprise graph system and encompasses the nodes and edges in a graph that affect the results of the query 128.

In various embodiments, the query footprint(s) are created based on the submitted query and includes specific types of content that are pertinent to the user's experience. For example, if a query is designed to retrieve documents modified within the last two days, the corresponding query footprint would include all documents and their modification timestamps within that timeframe. The event-augmented generation tool 104, in an embodiment, uses Bloom filters(s) 122 to store indexed representations of the query footprint(s) 124. In one example, Bloom filters(s) 122 enable the event-augmented generation tool 104 to determine that a particular ingress operation causes a change in a dataset associated with the query 128.

In an embodiment, the query footprint(s) 124 enable the event-augmented generation tool 104 to maintain client-side cache freshness and optimize the performance of the graph system by reducing unnecessary query executions and ensuring that relevant notifications are sent to the query owner. Moreover, in various embodiments, the resolution of the graph objects is used to determine the precision of the change detection mechanism. In one example, the Bloom filter(s) 122 tracks nodes by identifiers. As a result, any change to that node will result in a notification regardless of what data associated with the node is changed. In another example, the Bloom filter(s) 122 tracks nodes by identifiers and additionally tracks properties stored within the node, then notifications can be scoped to individual property changes. In the event of a higher-order structure for the graph, such as the node type (for instance, color), detection can be tracked at that level, in accordance with an embodiment. For relationship data, in an example, dependent changes cause changes to a relationship depending on adjacent nodes in the graph. In this example, in order to detect these changes, edges are encoded with information indicating adjacent nodes in the Bloom filter to detect alterations.

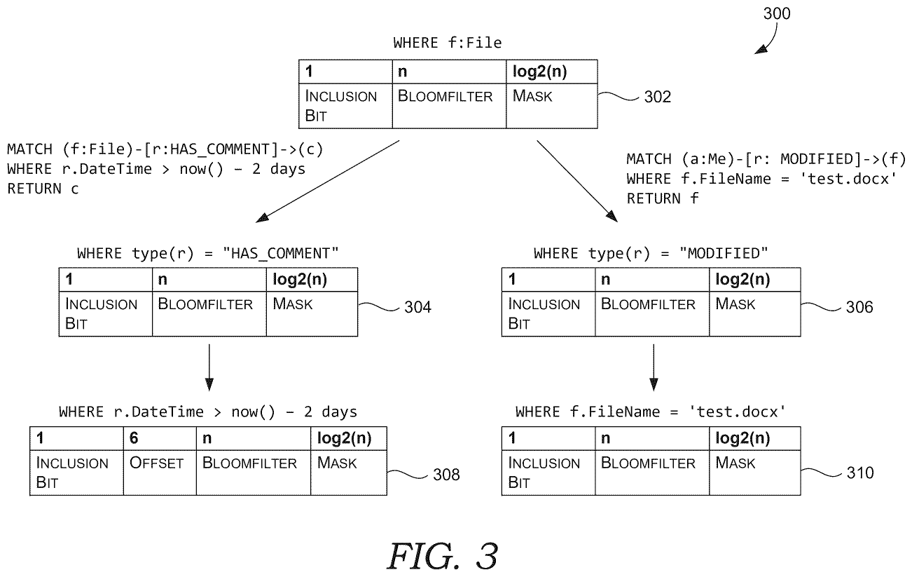

As described in greater detail below in connection with FIG. 3, predicate sets further refine the query footprint(s) 124 by modeling inclusion criteria for ingress event(s) 130 using mask(s) 126. In one example, a range defined in the query 128 is defined by a binary mask. Continuing this example, to determine inclusion for a given value within an ingress event (for instance, metadata included in the ingress event), a bitwise AND operation combining the mask and the value is performed and the result bits are used to query the Bloom filter associated with the query 128. In various embodiments, range predicates, temporal predicates, equivalence predicates, and/or other predicates of the query 128 are represented using the mask(s) 126.

In one example, temporal predicates are modeled as scalar values represented as a bitmask similar to range predicates described above. In addition, in various embodiments, temporal predicates also include the present time, which can cause responses to be altered as a result of being reevaluated over time. For example, a query to obtain all documents generated over the last two days includes a first value to represent the last two days and a second value to represent a clock skew for the query. Continuing this example, the predicate set is structured around the present time and is represented by the set S={t−1, t, ∞}, where t represents the current time and is subtracted from the first value as an offset to determine the value used as the mask in the predicate set to determine inclusion for a particular ingress event. In various embodiments, predicates that test for equality can be encoded by postfixing an identifier in the ingress event(s) 130 with the expected and/or predicate value. To test the inequality, in an embodiment, an inclusion bit is included in the predicate set to indicate how the outcome of querying the Bloom filter(s) 122 is handled.

In an embodiment, the predicate sets representing complex queries are organized into a hierarchical structure. For example, as illustrated in FIG. 3 described below, predicate sets (for instance, a mask and a Bloom filter) are placed in a tree structure in ascending order based on cardinality. In various embodiments, the most restrictive predicate is evaluated first in order to efficiently process the predicate sets and reduce computing resource utilization.

In various embodiments, in response to receiving the query 128, a Bloom filter is initialized with a size and a false positive rate in order to store the values associated with the query footprint associated with the query 128. In one example, the query 128 includes the predicate “count>5.” As a result, the query footprint includes the values represented by the set S={6, 7, 8, . . . ∞}. Continuing this example, the set S={6,7,8} is added to the Bloom filter, and a binary representation of the mask “11100” is generated and stored as a predicate set. In various embodiments, the inclusion test for a given value on a predicate is computed based on a bitwise AND operation combining the bitmask with the value is performed and resulting bits are used to query the Bloom filter. Returning to the example above, any value above eight will effectively be masked and map to the upper bound of the set, thereby expressing infinite values included in the range “count>5.”

In various embodiments, the mask(s) 126 filter out values outside a particular range by applying the mask(s) 126 to values included in the ingress events 130 prior to checking membership in the Bloom filter(s) 122. Additionally, in various embodiments, the predicate sets are normalized over the largest cardinality in the predicate set. In one example, the formula for computing the normalized cardinality includes:

$${C}_{normalized} = abs ( ( \vert S \vert / max ( \vert S \vert ) ) - I ) .$$

In various embodiments, this formula determines the normalized ratio between the current set cardinality and the maximum, compensating for inclusion. Additionally, in some examples, several query footprints share predicate sets, and the hierarchical ordering of predicate sets is augmented by a decision tree to determine which query footprint changed.

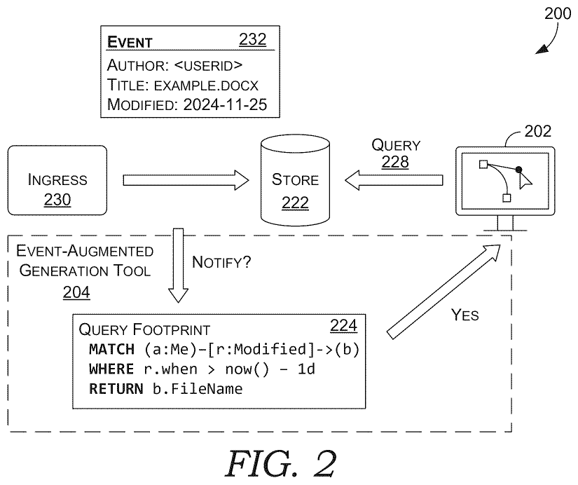

FIG. 2 is an environment 200 in which an event-augmented generation tool 204 processes ingress events 230 to determine whether to notify a client 202 based on a query 228, in accordance with an embodiment. In various embodiments, the client 202 includes any entities capable of submitting the query 128 to a data store 222. In one example, the client 202 includes a user submitting a standing query to be notified at the occurrence of a particular event (for instance, access to the data object or locations, creation and/or modification of the data object, changes to permission and/or access right, etc.). In other examples, the client 202 includes an application and/or portion thereof, such as an AI assistant and/or agent machine learning model, that submits the query 228 to the data store 222.

In various embodiments, the data store 222 includes various data storage systems such as a key-value store, relational data, graph storage, or other system that is capable of processing queries and retuning data. In one example, the data store 222 is provided as a service of a computing resource service provider such as the computing resource service provider 120 described above in connection with FIG. 1. In an embodiment, the event-augmented generation tool 204 determines a query footprint 224 associated with the query and generates, based on the query footprint 224, a predicate set representing the query footprint 224, which is used to determine that a particular ingress event modifies data associated with the query footprint and, as a result, a notification to the client 202 is transmitted.

In various embodiments, the query footprint 224 represents data stored in the data store 222 that satisfies the query 228. For example, as illustrated in FIG. 2, the query 228, expressed in the declarative graph pattern matching pseudocode is “MATCH (a:Me)-[r:MODIFIED]->(b); WHERE r1.WHEN>NOW—Id” and returns all documents that the user has modified (“a:Me)-[r:MODIFIED]”) in the last day (“r1.WHEN>NOW−1 d”). Continuing this example, the query footprint 224 includes all the documents in the data store 222 that satisfy this query and ingress events 130 that add documents to the data store 222 that satisfy the query (for instance, documents the user has modified in the last day) changes the query footprint 224 (for instance, by adding new documents to the data store 222 that satisfies the query).

The event-augmented generation tool 204, in an embodiment, monitors or otherwise inspects ingress events 130 to determine whether the query footprint 224 changes. In one example, the event-augmented generation tool 204 generates a Bloom filter by executing the query 228 and inserting the query footprint 224. Returning to the example above, the query 228 is represented by the set QF={a, r, b, r1}. Continuing this example, the event-augmented generation tool 204 checks ingress events 130, such as a new ingress event I, to determine whether I∩QF=Ø by querying the Bloom filter. In various embodiments, as a result of the new ingress event intersecting with the contents of the Bloom filter, the event-augmented generation tool 204 transmits a notification to the client 202. In response, in one example, the client 202 obtains the notification and re-executes the query 228.

In various embodiments, the event-augmented generation tool 204 generates a predicate set that includes a mask that represents the temporal predicate “r1. WHEN>NOW−1 d.” In this example, the temporal predicate is represented by the set S {t−1,t,∞} where t is the current date and time and is subtracted from the subject value as an offset to determine or otherwise compute the value used for inclusion in the predicate set. In various embodiments, the ingress events 230 include information and metadata that is extracted and/or otherwise inspected by the event-augmented generation tool 204 to determine whether to notify the client 202. In the example illustrated in FIG. 2, event data 232 includes author, title, and data modified information. In other examples, the event data 232 includes any data generated during the ingress events 230, an application generating the ingress operation, and/or used by the data store 222 to store the data associated with the ingress events 230.

FIG. 3 is an environment 300 in which an event-augmented generation maintains a plurality of predicate sets in a hierarchical structure for determining whether an ingress operation modifies a query footprint, in accordance with an embodiment. In the example illustrated in FIG. 3, the hierarchical structure includes a first predicate set 302, a second predicate set 304, a third predicate set 306, a fourth predicate set 308, and a fifth predicate set 310. In various embodiments, the predicate sets 302-310 are shared across multiple query footprints corresponding to a plurality of queries provided by at least one client. For example, predicate sets for a plurality of query footprints are organized into a tree structure to enable the event-augmented generation tool to evaluate a plurality of queries based on a single tree structure. In other embodiments, the predicate sets 302-310 represent a single query footprint corresponding to a complex query.

In various embodiments, a size of the mask for the predicate sets 302-310 is log 2 proportional to the Bloom filter size. In addition, in such embodiments, the size of the Bloom filter is determined based on an acceptable false positive rate and the expected number of values stored in the Bloom filter. For example, a predicate of “Count>5” and a mask representing the set S {6, 7, 8} where the inclusion is included to represent infinity, the Bloom filter size is at least thirty-four bits, where the computed probability for false positives is set to one percent.

As described above, in an embodiment, the predicate sets 302-310 are collections of Boolean conditions that define the criteria for data inclusion in a query. In one example, the predicate sets 302-310 model an inclusion mechanism for new ingress events, enabling the event-augmented generation tool to ensure that only relevant changes trigger updates to the query results. In various embodiments, at the nodes of the hierarchical structure, individual predicate sets are defined for specific conditions, each representing a single Boolean condition or a simple combination of conditions. In the example illustrated in FIG. 3, the predicate sets 302-310 represent a single predicate of a query, such as predicate set 304 representing the predicate “WHERE type(r)=“HAS_COMMENT,” which is pseudocode for filtering documents that have a comment included in the document.

In an embodiment, intermediate levels combine multiple base-level predicate sets to form more complex conditions, including logical operations such as “AND,” “OR,” and/or “NOT.” In one example, predicate set 304 is combined with predicate set 306 with an “AND” operation. Continuing this example, when evaluating the predicate sets 304 and 306, the event-augmented generation tool determines whether predicate set 304 is satisfied and, as a result of predicate set 304 being satisfied, determines whether predicate set 306 is satisfied.

In various embodiments, the predicate sets 302-310 are ordered based on their cardinality. For example, the predicate sets 302-310 are ordered based on the number of elements represented. In an embodiment, predicate sets with lower cardinality are evaluated first to enable early termination of the evaluation of an ingress event. For example, the event-augmented generation tool evaluates predicate sets hierarchically, starting from a first level and moving up to a top level, ensuring that simpler conditions are checked first, reducing the need for more complex evaluations. In various embodiments, the predicate sets are organized into a decision tree structure, where nodes represent a predicate set, and the tree is traversed to evaluate whether the ingress event modifies one or more query footprints. In various embodiments, the predicate sets 302-310 include a mask used during bitmasking operations to represent ranges and conditions. In one example, a Bloom filter is used to store indexed representations of predicate sets.

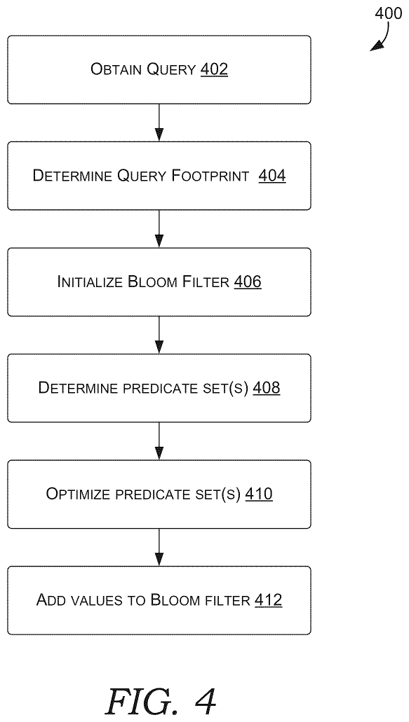

FIG. 4 is a flow diagram showing a method 400 for generating predicate sets and Bloom filters used to evaluate ingress events to determine whether to notify a client associated with a query, in accordance with at least one embodiment. The method 400 can be performed, for instance, by the event-augmented generation tool 104 of FIG. 1. Each block of the method 400, 500, and 600, and any other methods described herein, comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 402, the system implementing the method 400 obtains a query. As described above in connection with FIG. 1, in various embodiments, users, applications, machine learning models, and/or other entities can submit queries to data stores to obtain data. In one example, the queries include standing queries to notify a client when data objects satisfy the queries and are stored in the data store.

At block 404, the system implementing the method 400 determines a query footprint associated with the query. For example, the query footprint includes a representation of data that satisfies the query. At block 406, the system implementing the method 400 initializes the Bloom filter. In one example, the Bloom filter is initialized based on a size of the query footprint (for instance, the number of elements and/or values to be stored in the Bloom filter) and a false positive rate.

At block 408, the system implementing the method 400 determines predicate set(s) associated with the query footprint. In one example, the predicate sets represent predicates and/or Boolean operations included in the query. In an embodiment, the predicate sets include an inclusion bit to represent infinite ranges and/or negation, a mask to represent ranges and temporal predicates, and a Bloom filter. At block 410, the system implementing the method 400 optimizes the predicate set(s). For example, the predicate sets are organized into a hierarchical structure such as a decision tree. In various embodiments, predicate sets for a plurality of queries are organized into a single decision tree and/or hierarchical structure. At block 412, the system implementing the method 400 adds values to the Bloom filter 412. For example, the query is executed and values obtained are added to the Bloom filter.

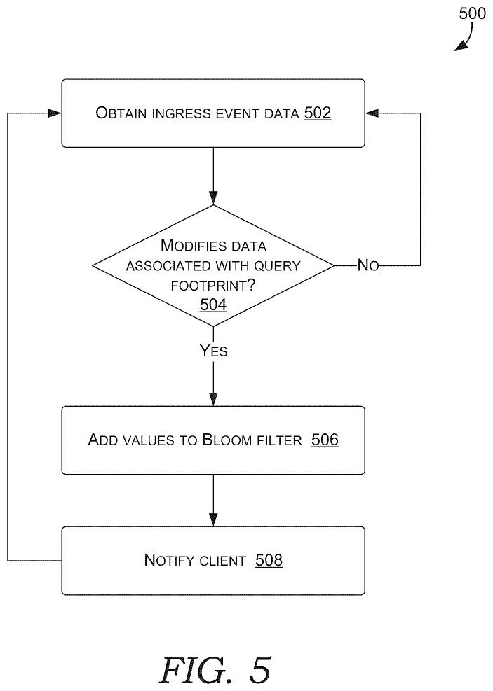

FIG. 5 is a flow diagram showing a method 500 for determining whether to notify a client based on an ingress event and a query footprint, in accordance with at least one embodiment. The method 500 can be performed, for instance, by the event-augmented generation tool 104 of FIG. 1. As shown at block 502, the system implementing the method 500 obtains ingress event data. For example, a data store service generates metadata and/or other data associated with an ingress operation and provides the metadata and/or other data to the event-augmented generation tool. At block 504, the system implementing the method 500 determines whether the ingress event modifies data associated with the query footprint. For example, as described above, the event-augmented generation tool utilizes a decision tree including a plurality of predicate sets to determine whether the ingress event modifies data associated with the query footprint (for instance, if the ingress operations change the results of a query associated with the query footprint). If the ingress event does not modify data associated with the query footprint, the system implementing the method 500 returns to block 502 and processes the next ingress event.

If the ingress event does modify data associated with the query footprint, the system implementing the method 500 continues to block 506. At block 506, the system implementing the method 500 adds values to the Bloom filter 412. For example, the data included in the ingress event data is added to the Bloom filter. At block 508, the system implementing the method 500 notifies the client. For example, the event-augmented generation tool notifies an agent, such as a machine learning model, that data used by the model to generate an output has been updated and/or modified.

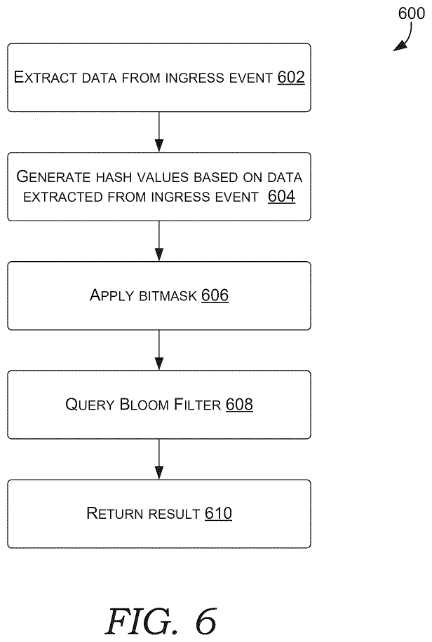

FIG. 6 is a flow diagram showing that a method 600 for determining data included in an ingress event modifies a query footprint, in accordance with at least one embodiment. The method 600 can be performed, for instance, by the event-augmented generation tool 104 of FIG. 1. For example, the event-augmented generation tool determines whether the ingress event modifies data associated with the query footprint such as at block 504 of FIG. 5 as described above. Returning to FIG. 6, as shown at block 602, the system implementing the method 600 extracts data from the ingress event. For example, the system implementing the method 600 obtains data used to query the Bloom filter, such as user identification information, file name, date and time information, type of data object, attributes of the data object, or any other data useable to evaluate a query.

At block 604, the system implementing the method 600 generates hash values based on the data extracted from the ingress event. For example, one or more hash algorithms are used to generate the hash values used to query the Bloom filter. At block 606, the system implementing the method 600 applies a bitmask. For example, as described above, a predicate set includes a mask that is combined with the hash value using a bitwise AND operation. At block 608, the system implementing the method 600 queries the Bloom filter to determine inclusion. For example, a bit array generated based on the hash of the data combined with the bitmask is compared to the values in the Bloom filter to determine inclusion. At block 610, the system implementing the method 600 returns the result.

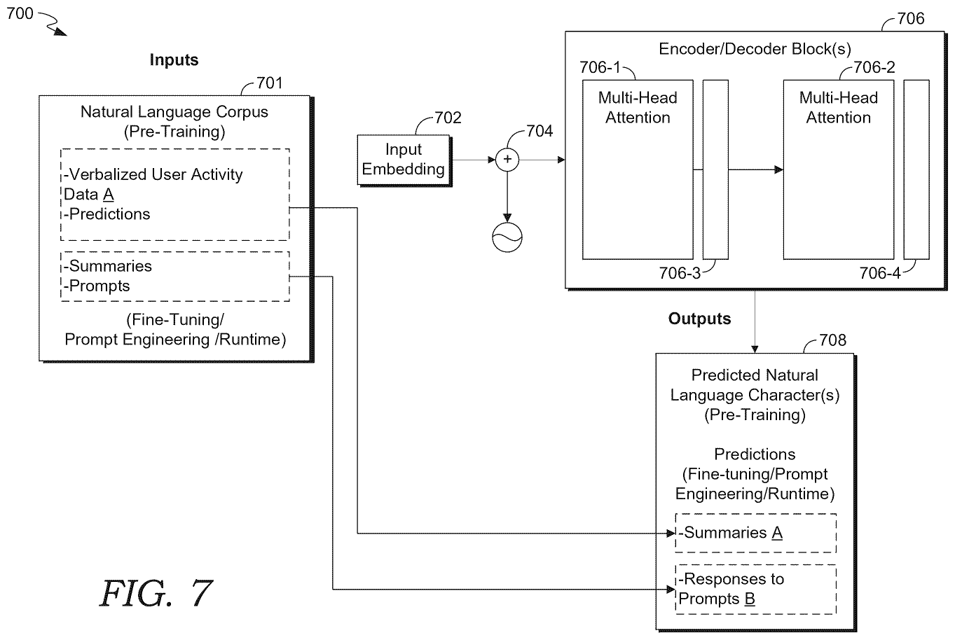

FIG. 7 is a block diagram of a Large Language Model 700 (e.g., a BERT model or GPT-4 model) that uses particular inputs to make particular predictions (e.g., answers to questions), according to some embodiments. In some embodiments, this model 700 represents or includes the functionality as described with respect to the machine learning models 120 and/or the AI assistant 118 of FIG. 1. In various embodiments, the language model 700 includes one or more encoders and/or decoder blocks 706 (or any transformer or portion thereof).

First, a natural language corpus (e.g., various WIKIPEDIA English words or BooksCorpus) of the inputs 701 are converted into tokens and then feature vectors and embedded into an input embedding 702 to derive meaning of individual natural language words (for example, English semantics) during pre-training. In some embodiments, to understand English language, corpus documents, such as text books, periodicals, blogs, social media feeds, and the like are ingested by the language model 700.

In some embodiments, each word or character in the input(s) 701 is mapped into the input embedding 702 in parallel or at the same time, unlike existing long short-term memory (LSTM) models, for example. The input embedding 702 maps a word to a feature vector representing the word. But the same word (for example, “apple”) in different sentences may have different meanings (for example, brand versus fruit). This is why a positional encoder 704 can be implemented. A positional encoder 704 is a vector that gives context to words (for example, “apple”) based on a position of a word in a sentence. For example, with respect to a message “I just sent the document,” because “I” is at the beginning of a sentence, embodiments can indicate a position in an embedding closer to “just,” as opposed to “document.” Some embodiments use a sine/cosine function to generate the positional encoder vector as follows:

$${PE}_{( pos , 2 i )} = sin ( pos / {10000}^{2 i / {d}_{model}} )$$

$${PE}_{( pos , 2 i + 1 )} = cos ( pos / {10000}^{2 i / {d}_{model}} ) .$$

After passing the input(s) 701 through the input embedding 702 and applying the positional encoder 704, the output is a word embedding feature vector, which encodes positional information or context based on the positional encoder 704. These word embedding feature vectors are then passed to the encoder and/or decoder block(s) 706, where they go through a multi-head attention layer 706-1 and a feedforward layer 706-2. The multi-head attention layer 706-1 is generally responsible for focusing or processing certain parts of the feature vectors representing specific portions of the input(s) 701 by generating attention vectors. For example, in Question Answering systems, the multi-head attention layer 706-1 determines how relevant the i^{th} word (or particular word in a sentence) is for answering the question or its relevance to other words in the same or other blocks, the output of which is an attention vector. For every word, some embodiments generate an attention vector, which captures contextual relationships between other words in the same sentence or other sequences of characters. For a given word, some embodiments compute a weighted average or otherwise aggregate attention vectors of other words that contain the given word (for example, other words in the same line or block) to compute a final attention vector.

In some embodiments, a single-headed attention has abstract vectors Q, K, and V that extract different components of a particular word. These are used to compute the attention vectors for every word, using the following formula:

$$Z = softmax ( \frac{Q \cdot {K}^{T}}{\sqrt{Dimension of vector Q , K , or V}} ) \cdot V$$

For multi-headed attention, there are multiple weight matrices W^{q}, W^{k}, and W^{v}, so there are multiple attention vectors Z for every word. However, a neural network may only expect one attention vector per word. Accordingly, another weighted matrix, W^{z}, is used to make sure the output is still an attention vector per word. In some embodiments, after the layers 706-1 and 706-2, there is some form of normalization (for example, batch normalization and/or layer normalization) performed to smoothen out the loss surface, making it easier to optimize while using larger learning rates.

Layers 706-3 and 706-4 represent residual connection and/or normalization layers where normalization recenters and rescales or normalizes the data across the feature dimensions. The feedforward layer 706-2 is a feedforward neural network that is applied to every one of the attention vectors outputted by the multi-head attention layer 706-1. The feedforward layer 706-2 transforms the attention vectors into a form that can be processed by the next encoder block or that can make a prediction at 708. For example, given that a document includes a first natural language sequence “the due date is . . . ” the encoder/decoder block(s) 706 predicts that the next natural language sequence will be a specific date or particular words based on past documents that include language identical or similar to the first natural language sequence.

In some embodiments, the encoder/decoder block(s) 706 includes pre-training to learn language (pre-training) and make corresponding predictions. In some embodiments, there is no fine-tuning because some embodiments perform prompt engineering, prompt tuning, or zero-shot learning. “Prompt engineering” refers to a process of designing or using structured input to the model (referred to as a prompt or prompts) to cause a desired response to be generated by the model. In some embodiments, prompt engineering includes creating the best or optimal prompt, or series of prompts, for the desired user task or output. Accordingly, given a first prompt (which may include target content), if the model produces a first output with a high likelihood of not being the correct response, particular embodiments learn, such that a second output (indicative of a high likelihood of being a correct response) is always produced when such a first prompt is provided as input. In this way, at model deployment time, no output is ever produced with a low likelihood of being the correct response if the first prompt (or variation thereof) is provided, thereby increasing the accuracy of the model's generative outputs.

Pre-training is performed to understand language, and fine-tuning is performed to learn a specific task, such as learning an answer to a set of questions (in Question Answering systems). In some embodiments, the encoder/decoder block(s) 706 learns what language and context for a word are in pre-training by training on two unsupervised tasks (MLM and NSP) simultaneously or at the same time. In terms of the inputs and outputs, at pre-training, the natural language corpus of the inputs 701 may be various historical documents, such as text books, journals, and periodicals, in order to output the predicted natural language characters in 708 (not make the predictions at runtime or prompt engineering at this point). The encoder/decoder block(s) 706 takes in a sentence, paragraph, or sequence (for example, included in the input(s) 701), with random words being replaced with masks. The goal is to output the value or meaning of the masked tokens. For example, if a line reads, “please [MASK] this document promptly,” the prediction for the “mask” value is “send.” This helps the encoder/decoder block(s) 706 understand the bidirectional context in a sentence, paragraph, or line at a document. In the case of NSP, the encoder/decoder block(s) 706 takes, as input, two or more elements, such as sentences, lines, or paragraphs, and determines, for example, if a second sentence in a document actually follows (for example, is directly below) a first sentence in the document. This helps the encoder/decoder block(s) 706 understand the context across all the elements of a document, not just within a single element. Using both of these together, the encoder/decoder block(s) 706 derives a good understanding of natural language.

In some embodiments, during pre-training, the input to the encoder/decoder block(s) 706 is a set (for example, 2) of masked sentences (sentences for which there are one or more masks), which could alternatively be partial strings or paragraphs. In some embodiments, each word is represented as a token, and some of the tokens are masked. Each token is then converted into a word embedding (for example, 702). At the output side is the binary output for the next sentence prediction. For example, this component may output 1, for example, if masked sentence 2 followed (for example, was directly beneath) masked sentence 1. The outputs are word feature vectors that correspond to the outputs for the machine learning model functionality. Thus, the number of word feature vectors that are input is the same number of word feature vectors that are output.

In some embodiments, the initial embedding (for example, the input embedding 702) is constructed from three vectors: the token embeddings, the segment or context question embeddings, and the position embeddings. In some embodiments, the following functionality occurs in the pre-training phase. The token embeddings are the pre-trained embeddings. The segment embeddings are the sentence numbers (that include the input[s] 701) that are encoded into a vector (for example, first sentence, second sentence, etc., assuming a top-down and right-to-left approach). The position embeddings are vectors that represent the position of a particular word in such a sentence that can be produced by positional encoder 704. When these three embeddings are added or concatenated together, an embedding vector is generated that is used as input into the encoder/decoder block(s) 706. The segment and position embeddings are used for temporal ordering since all of the vectors are fed into the encoder/decoder block(s) 706 simultaneously, and language models need some sort of order preserved.

In pre-training, the output is typically a binary value C (for NSP) and various word vectors (for MLM). With training, a loss (for example, cross-entropy loss) is minimized. In some embodiments, all the feature vectors are of the same size and are generated simultaneously. As such, each word vector can be passed to a fully connected layered output with the same number of neurons equal to the same number of tokens in the vocabulary.

In some embodiments, once pre-training is performed, the encoder/decoder block(s) 706 performs prompt engineering or fine-tuning on a variety of datasets by converting different QA formats into a unified sequence-to-sequence format. For example, some embodiments perform the QA task by adding a new question answering head or encoder/decoder block, just the way a masked language model head is added (in pre-training) for performing an MLM task, except that the task is a part of prompt engineering or fine-tuning. This includes the encoder/decoder block(s) 706 processing the inputs 701 (i.e., the verbalized user activity data, the predictions, summaries, and/or prompts) in order to make the predictions and confidence scores as indicated in 708. Prompt engineering, in some embodiments, is the process of crafting and optimizing text prompts for language models to achieve desired outputs. In other words, prompt engineering is the process of mapping prompts (e.g., a question) to the output (e.g., an answer) that it belongs to for training. For example, if a user asks a model to generate a poem about a person fishing on a lake, the expectation is that it will generate a different poem each time. Users may then label the output or answers from best to worst. Such labels are an input to the model to make sure the model is giving more human-like or best answers, while trying to minimize the worst answers (e.g., via reinforcement learning). In some embodiments, a “prompt” as described herein includes one or more of: a request (e.g., a question or instruction [e.g., write a poem]), target content, a command or instruction, and/or more examples (e.g., one-shot or two-shot examples).

In an illustrative example, in some embodiments, the predictions of the output 708 may be generative text, chart, graphs, or other visualizations, such as those described above with FIGS. 4A and 4B. Alternative to prompt engineering or fine-tuning, in some embodiments the inputs 701 and outputs 708 represent “runtime” inputs and outputs. Runtime represents a time after which the model 700 has been trained (e.g., via pre-training and/or fine-tuning and/or prompt engineering), tested, and deployed.

An artificial intelligence (AI) system refers to an artificial intelligence computing environment or architecture that includes the infrastructure and components that support the development, training, and deployment of artificial intelligence models. It provides necessary hardware, software, and frameworks for developers to create and run artificial intelligence applications. An artificial intelligence system may be a cloud-based AI solution that leverages cloud computing infrastructure to develop, train, deploy, and manage AI models and applications. AI models may specifically refer to generative AI models that are designed to generate new data or content that is similar to, or in some cases, entirely different from data they are trained on.

Artificial intelligence systems can include transformer models that are capable of running complex neural language processing tasks. Transformer models—also known as Large Language Models (LLMs)—have applications in a wide range of industries. An LLM is a trained deep learning model that can recognize, summarize, translate, predict, and generate content using very large datasets. LLMs and other types of generative AI models are associated with a training phase—where a model is taught to learn patterns, relationships, and knowledge from training datasets—and an inference phase, which includes making predictions, classifications, or generating outputs for real-world tasks or queries.

Unlike convolution neural networks, which are typically used for image tasks and mostly rely on convolution operations, transformer models are based on simple general matrix multiplication (GEMM) tasks, which can be further broken down to perform a dot product operation on two vectors. While Convolutional Neural Network (CNN) architectures are typically computationally heavy with a relatively small number of parameters, the architecture of transformer models results in the opposite: a very large number of parameters, with a fairly small number of operations. The LLM architecture can create challenges in that performance bottlenecks reside in the memory throughput and capacity rather than the compute engine.

Transformer models operate with memory accesses to retrieve a matrix of weights out of memory, together with a vector (either the input vector or partial result from a previous stage of the model), and multiplying the two. This is true for the model's attention sublayers, the FFN (feedforward network), sublayers, and for the final embedding layer. As vector-matrix multiplication is actually comprised of numerous vector-vector multiplications (dot product), it is fair to say that most memory accesses are used to read two vectors in order to perform a dot product on them. As such, reading out the full vectors is inefficient.

As such, transformer models (also referred to herein as “generative AI models”) require computational resources including processors and memory for the training phase and inference phase. The generative AI models operate with different types of processors (e.g., central processing units [CPUs] or graphics processing unit [GPUs]) in architectures that include multi-core CPUs or parallel processors including GPUs and tensor processing units (TPUs). Memory can be used to store model parameters and intermediate data for the training phase and the inference phase. Memory requirements may depend on the size and the architecture of the generative AI models. By way of illustration, an LLM can support an inferencing phase that includes using a trained model to make predictions, draw conclusions, or generate output based on input data or patterns learned during the model's training phase. During the inference phase, an LLM can use DRAM (Dynamic Random-Access Memory) to store various components and data for making inferences. LLMs can store their pre-trained model parameters (e.g., weights and biases of the neural network layers) in DRAM, and when a new input is provided for inference, the model accesses these parameters from DRAM to make predictions.

The inference phase can be divided into two stages: a prompt stage and an auto-regressive stage. The prompt stage can include receiving and processing input as a batch of new tokens as part of the same inference. The prompt stage may operate based on a Key-Value (KV) cache technique, where a KV cache is created for tokens in a batch. During the prompt stage, the input is being digested. The auto-regressive state can include using the model to generate the tokens one by one, based on previous tokens, relying on reading the KV cache of previously processed tokens, and adding the data of only new tokens to the KV cache. This auto-regressive stage includes the model generating a response to the input from the prompt stage.

Having described embodiments of the present disclosure, FIG. 8 provides an example of a computing device in which embodiments of the present disclosure may be employed. Computing device 800 includes bus 810 that directly or indirectly couples the following devices: memory 812, one or more processors 814, one or more presentation components 816, input/output (I/O) ports 818, input/output components 820, and illustrative power supply 822. Bus 810 represents what may be one or more buses (such as an address bus, data bus, or combination thereof). Although the various blocks of FIG. 8 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 8 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 8 and make reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, Random Access Memory (RAM), Read-Only Memory (ROM), Electrically Erasable Programmable Read-Only Memory (EEPROM), flash memory or other memory technology, digital versatile disks (DVDs) or other optical disk storage, magnetic cassettes, magnetic tape, magnetic disk storage or other magnetic storage devices, or any other medium that can be used to store the desired information and which can be accessed by computing device 800. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, infrared, and other wireless media. Combinations of any of the above should also be included within the scope of computer-readable media.

Memory 812 includes computer storage media in the form of volatile and/or nonvolatile memory. As depicted, memory 812 includes instructions 824. Instructions 824, when executed by processor(s) 814, are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built-in. Illustrative components include a microphone, joystick, game pad, satellite dish, scanner, printer, wireless device, etc. I/O components 820 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 800. Computing device 800 may be equipped with depth cameras, such as stereoscopic camera systems, infrared camera systems, camera systems, and combinations of these, for gesture detection and recognition. Additionally, computing device 800 may be equipped with accelerometers or gyroscopes that enable detection of motion. The output of the accelerometers or gyroscopes may be provided to the display of computing device 800 to render immersive augmented reality or virtual reality.

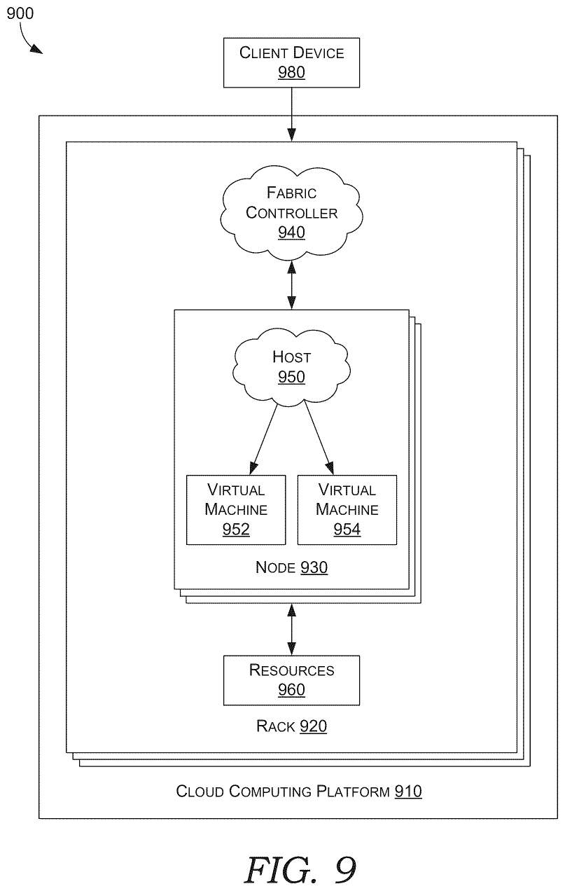

Referring now to FIG. 9, FIG. 9 illustrates an example distributed computing environment 900 in which implementations described in the present disclosure may be employed. In particular, FIG. 9 shows a high-level architecture of an example cloud computing platform 910 that can host a virtualization environment. It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 900 that includes cloud computing platform 910, rack 920, and node 930 (e.g., computing devices, processing units, or blades) in rack 920. The virtualization environment can be implemented with cloud computing platform 910 that runs cloud services across different data centers and geographic regions. Cloud computing platform 910 can implement a fabric controller 940 component for provisioning and managing resource allocation, deployment, upgrade, and management of cloud services. Typically, cloud computing platform 910 acts to store data or run service applications in a distributed manner. Cloud computing platform 910 in a data center can be configured to host and support operation of endpoints of a particular service application. Cloud computing platform 910 may be a public cloud, a private cloud, or a dedicated cloud.

Node 930 can be provisioned with host 950 (e.g., operating system or runtime environment) running a defined software stack on node 930. Node 930 can also be configured to perform specialized functionality (e.g., compute nodes or storage nodes) within cloud computing platform 910. Node 930 is allocated to run one or more portions of a service application of a tenant. A tenant can refer to a customer utilizing resources of cloud computing platform 910. Service application components of cloud computing platform 910 that support a particular tenant can be referred to as a tenant infrastructure or tenancy. The terms “service application,” “application,” or “service” are used interchangeably herein and broadly refer to any software, or portions of software, that run on top of, or access storage and compute device locations within, a datacenter.

When more than one separate service application is being supported by nodes 930, nodes 930 may be partitioned into virtual machines (e.g., virtual machine 952 and virtual machine 954). Physical machines can also concurrently run separate service applications. The virtual machines or physical machines can be configured as individualized computing environments that are supported by resources 960 (e.g., hardware resources and software resources) in cloud computing platform 910. It is contemplated that resources can be configured for specific service applications. Further, each service application may be divided into functional portions such that each functional portion is able to run on a separate virtual machine. In cloud computing platform 910, multiple servers may be used to run service applications and perform data storage operations in a cluster. In particular, the servers may perform data operations independently but exposed as a single device referred to as a cluster. Each server in the cluster can be implemented as a node.

Client device 980 may be linked to a service application in cloud computing platform 910. Client device 980 may be any type of computing device, which may correspond to computing device 900 described with reference to FIG. 9, for example. Client device 980 can be configured to issue commands to cloud computing platform 910. In some implementations, client device 980 may communicate with service applications through a virtual Internet Protocol (IP) and load balancer or other means that direct communication requests to designated endpoints in cloud computing platform 910. The components of cloud computing platform 910 may communicate with each other over a network (not shown), which may include one or more local area networks (LANs) and/or wide area networks (WANs).

### OTHER EMBODIMENTS

The following embodiments represent example literal support clauses and embodiments of concepts contemplated herein. Any one of the following embodiments may be combined in a multiple dependent manner to depend from one or more other embodiments. Further, any combination of dependent embodiments (e.g., clauses that explicitly depend from a previous embodiment) may be combined while staying within the scope of aspects contemplated herein. The following embodiments are exemplary in nature and are not limiting.

In some embodiments, a system, such as a method comprising obtaining data corresponding to an ingress event associated with a data store and determining the data modifies a query footprint associated with a query by at least: generating a hash value based on the data, applying a bitmask to the hash value based on a mask included in a predicate set associated with the query, querying a Bloom filter included in the predicate set, and transmitting to a client associated with the query an indication that the ingress operation modifies the query footprint.

In any combination of the above embodiments of the method, wherein determining the data modifies the query footprint further comprises: generating a second hash value based on second data obtained from the ingress event, applying a second bitmask to the second hash values based on a second mask included in a second predicate set associated with the query, and querying a second Bloom filter included in the second predicate set.

In any combination of the above embodiments of the method, wherein the first predicate and the second predicate are stored in a hierarchical structure.

In any combination of the above embodiments of the method, wherein hierarchical structure includes a decision tree.

In any combination of the above embodiments of the method, wherein transmitting to the client associated with the query the indication that the ingress operation modifies the query footprint is based on a result of querying the Bloom filter and the second Bloom filter indicating inclusion of the data in the Bloom filter and inclusion of the second data in the second Bloom filter.

In any combination of the above embodiments of the method, wherein the method further comprises adding the data to the Bloom filter.

In any combination of the above embodiments of the method, wherein the query is obtained from a machine learning model.

In some embodiments, a non-transitory computer-readable medium storing executable instructions embodied thereon, that, as a result of being executed by a processing device, cause the processing device to perform operations comprising; obtaining a query from a client, determining a query footprint associated with the query, the query footprint indicating data that satisfies the query, generating a predicate set associated with the query footprint based on a predicate included in the query by at least generating a mask corresponding to the predicate, generating a Bloom filter associated with the predicate set, the Bloom filter storing values that satisfy the predicate included in the query, and evaluating an ingress event based on the predicate set.

In any combination of the above embodiments of the medium, wherein the operations further comprise generating a second predicate set based on a second predicate included in the query.

In any combination of the above embodiments of the medium, wherein the operations further comprise storing the predicate and the second predicate in a hierarchical data structure based on a cardinality associated with the predicate.

In any combination of the above embodiments of the medium, wherein the predicate includes at least one of: an equality predicate, a range predicate, a set membership predicate, a pattern matching predicate, a Boolean predicate, a temporal predicate, a negation predicate, and an existence predicate.

In any combination of the above embodiments of the medium, wherein the mask includes a set of bits representing the predicate.

In any combination of the above embodiments of the medium, wherein the set of bits represent a set of values indicated in the predicate.

In any combination of the above embodiments of the medium, wherein the set of values represent a range of values that satisfy the predicate.

In any combination of the above embodiments of the medium, wherein evaluating the ingress event further comprises; extracting metadata from the ingress event, generating a hash value based on the metadata and a hash function, applying the mask to the hash value to generate a result, and querying the Bloom filter based on the result.

In some embodiments, a system comprising: a memory component; and a processing device coupled to the memory component, the processing device to perform operations comprising: detecting an ingress event, determining the ingress event modifies a query footprint associated with a query by at least evaluating the ingress event based on a predicate set associated with the query footprint, the predicate set including a mask applied to data included in the ingress event and a Bloom filter to determine inclusion in the query footprint, and transmitting an indication that the ingress operation modifies the query footprint to a client associated with the query.

In any combination of the above embodiments of the system, wherein determining the ingress event modifies the query footprint associated with the query further comprises evaluating the ingress event based on a second predicate set associated with the query footprint.

In any combination of the above embodiments of the system, wherein the operations further comprise: obtaining the query, generating the mask to represent a set of values that satisfy a predicate included in the query, and storing the set of values in the Bloom filter.

In any combination of the above embodiments of the system, wherein evaluating the ingress event further comprises evaluating a plurality of predicate sets maintained in a decision tree.

In any combination of the above embodiments of the system, wherein the predicate set represents a predicate included in the query, the predicate including at least one of: an equality predicate, a range predicate, a set membership predicate, a pattern matching predicate, a Boolean predicate, a temporal predicate, a negation predicate, and an existence predicate.

### REMARKS

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B, and C” means “(A), (B), (C), (A and B), (A and C), (B and C), or (A, B, and C).”

What is claimed is:

1. A method comprising:
obtaining data corresponding to an ingress event associated with a data store; and
determining the data modifies a query footprint associated with a query by at least:
generating a hash value based on the data;
applying a bitmask to the hash value based on a mask included in a predicate set associated with the query;
querying a Bloom filter included in the predicate set; and
transmitting to a client associated with the query an indication that the ingress operation modifies the query footprint.

2. The method of claim 1, wherein determining the data modifies the query footprint further comprises:
generating a second hash value based on second data obtained from the ingress event;
applying a second bitmask to the second hash values based on a second mask included in a second predicate set associated with the query; and
querying a second Bloom filter included in the second predicate set.

3. The method of claim 2, wherein the first predicate and the second predicate are stored in a hierarchical structure.

4. The method of claim 3, wherein hierarchical structure includes a decision tree.

5. The method of claim 2, wherein transmitting to the client associated with the query the indication that the ingress operation modifies the query footprint is based on a result of querying the Bloom filter and the second Bloom filter indicating inclusion of the data in the Bloom filter and inclusion of the second data in the second Bloom filter.

6. The method of claim 1, wherein the method further comprises adding the data to the Bloom filter.

7. The method of claim 1, wherein the query is obtained from a machine learning model.

8. A non-transitory computer-readable medium storing executable instructions embodied thereon, that, as a result of being executed by a processing device, cause the processing device to perform operations comprising:
obtaining a query from a client;
determining a query footprint associated with the query, the query footprint indicating data that satisfies the query;
generating a predicate set associated with the query footprint based on a predicate included in the query by at least generating a mask corresponding to the predicate;
generating a Bloom filter associated with the predicate set, the Bloom filter storing values that satisfy the predicate included in the query; and
evaluating an ingress event based on the predicate set.

9. The medium of claim 8, wherein the operations further comprise generating a second predicate set based on a second predicate included in the query.

10. The medium of claim 9, wherein the operations further comprise storing the predicate and the second predicate in a hierarchical data structure based on a cardinality associated with the predicate.

11. The medium of claim 8, wherein the predicate includes at least one of: an equality predicate, a range predicate, a set membership predicate, a pattern matching predicate, a Boolean predicate, a temporal predicate, a negation predicate, and an existence predicate.

12. The medium of claim 8, wherein the mask includes a set of bits representing the predicate.

13. The medium of claim 12, wherein the set of bits represent a set of values indicated in the predicate.

14. The medium of claim 13, wherein the set of values represent a range of values that satisfy the predicate.

15. The medium of claim 8, wherein evaluating the ingress event further comprises:
extracting metadata from the ingress event;
generating a hash value based on the metadata and a hash function;
applying the mask to the hash value to generate a result; and
querying the Bloom filter based on the result.

16. A system comprising:
a memory component; and
a processing device coupled to the memory component, the processing device to perform operations comprising:
detecting an ingress event;
determining the ingress event modifies a query footprint associated with a query by at least evaluating the ingress event based on a predicate set associated with the query footprint, the predicate set including a mask applied to data included in the ingress event and a Bloom filter to determine inclusion in the query footprint; and
transmitting an indication that the ingress operation modifies the query footprint to a client associated with the query.

17. The system of claim 16, wherein determining the ingress event modifies the query footprint associated with the query further comprises evaluating the ingress event based on a second predicate set associated with the query footprint.

18. The system of claim 16, wherein the operations further comprise:
obtaining the query;
generating the mask to represent a set of values that satisfy a predicate included in the query; and
storing the set of values in the Bloom filter.

19. The system of claim 16, wherein evaluating the ingress event further comprises evaluating a plurality of predicate sets maintained in a decision tree.

20. The system of claim 16, wherein the predicate set represents a predicate included in the query, the predicate including at least one of: an equality predicate, a range predicate, a set membership predicate, a pattern matching predicate, a Boolean predicate, a temporal predicate, a negation predicate, and an existence predicate.
